(19) United States
(12) Patent Application Publication
(10) Pub. No.: US 2006/0102075 A1
(43) Pub. Date: May 18, 2006

(54) Fluid flow control

(76) Inventors: Austin A. Saylor, Sylvania, OH (US); Douglas L. Rogers, Toledo, OH (US)

Correspondence Address: BARNES & THORNBURG, 11 SOUTH MERIDIAN, INDIANAPOLIS, IN, 46204, US

(21) Appl. No.: 11/029,952

(22) Filed: Jan. 5, 2005

Related U.S. Application Data
(60) Provisional application No. 60/629,281, filed on Nov. 18, 2004.

(51) Int. Cl. B05C 11/00; B05C 5/00

(52) U.S. Cl. 118/692; 118/665; 118/313

(57) ABSTRACT

Apparatus and a method for dispensing coating material through multiple dispensing devices. The apparatus includes a first pressure sensor which senses the pressure of a stream at a common point in a flow circuit and a number of second pressure sensors. Each of the second pressure sensors senses flow through a respective channel in the flow circuit. The apparatus further includes a controller for controlling the flows of the streams in the respective channels based upon the combined inputs of the first pressure sensor and second pressure sensors.

### CROSS REFERENCE TO RELATED APPLICATIONS

This application claims the benefit under 35 U.S.C. 119(e) of the Nov. 18, 2004 filing date of U.S. Ser. No. 60/629,281, the complete disclosure of which is hereby incorporated herein by reference. U.S. Ser. No. 60/629,281 is owned by the same assignee as this application.

### FIELD OF THE INVENTION

This invention relates to methods and apparatus for the control of fluid flow. It is disclosed in the context of a controller for controlling the flow rate of a stream of air in a system for the atomization and dispensing of liquid coating material or pulverulent coating material (hereinafter collectively sometimes paint) entrained in a stream of air or other gas or mixture of gases (hereinafter collectively sometimes air). However, it is believed to be useful in other applications as well.

### BACKGROUND OF THE INVENTION

A number of control strategies and equipment for controlling, for example, the flow rates of fluent materials, are known. There are, for example, the methods and apparatus illustrated and described in U.S. Pat. Nos. 6,589,341, 6,537,378, 6,443,670 and 6,382,521. The disclosures of these references are hereby incorporated herein by reference. This listing is not intended to be a representation that a complete search of all relevant art has been made, or that no more pertinent art than that listed exists, or that the listed art is material to patentability. Nor should any such representation be inferred.

### DISCLOSURE OF THE INVENTION

According to one aspect of the invention, apparatus for dispensing coating material through multiple dispensing devices includes a first pressure sensor which senses the pressure of a stream at a common point in a flow circuit and a number of second pressure sensors, each of which senses flow through a respective channel in the flow circuit. The apparatus further includes a controller for controlling the flows of the stream in the respective channels based upon the combined inputs of the first pressure sensor and second pressure sensors.

Illustratively according to this aspect of the invention, the apparatus further includes a two conductor serial connection a first conductor of which provides a clock signal and a second conductor of which provides a data signal. The controller includes a remote module and a sensor module. Data is transferred from the sensor module to the remote module via the two conductor serial connection.

Illustratively according to this aspect of the invention, the sensor module and remote module comprise a remote module for setting the first conductor high and waiting for the sensor module to drive the second conductor high in response, then the remote module driving the first conductor low, waiting a time, driving the first conductor high, and then sampling the signal on the second conductor to recover data from the sensor module.

Illustratively according to this aspect of the invention, the sensor module and remote module comprise a the sensor module and remote module for conducting the sequence once for each bit of data that is transferred from the sensor module to the remote module.

Illustratively according to this aspect of the invention, the remote module and sensor module comprise a remote module and sensor module for sending data from the remote module to the sensor module via the two conductor serial connection to calibrate the sensor module.

Illustratively according to this aspect of the invention, the remote module and sensor module for sending data from the remote module to the sensor module via the two conductor serial connection to calibrate the sensor module comprise a remote module and sensor module for sending data from the remote module to the sensor module via the first conductor.

Illustratively according to this aspect of the invention, the apparatus further comprises an analog-to-digital (A/D) converter for each second pressure sensor.

Illustratively according to this aspect of the invention, the apparatus further includes a microcontroller (μC) in the flow sensor module. The A/D converted pressure signals are coupled to the μC.

Illustratively according to this aspect of the invention, the A/D converted pressure signals to the μC are time division multiplexed.

Illustratively according to this aspect of the invention, the μC converts the differences in pressure between the pressures sensed by respective second pressure sensors and the pressure sensed by the first pressure sensor into a flow rate in each respective channel.

Illustratively according to this aspect of the invention, the apparatus further includes means for storing pressure differentials and corresponding flow rates.

Illustratively according to this aspect of the invention, the μC converts the differences in pressure between the pressures sensed by respective second pressure sensors and the pressure sensed by the first pressure sensor into a flow rate in each respective channel among the stored pressure differentials and corresponding flow rates using interpolation.

Illustratively according to this aspect of the invention, the μC converts the differences in pressure between the pressures sensed by respective second pressure sensors and the pressure sensed by the first pressure sensor into a flow rate in each respective channel among the stored pressure differentials and corresponding flow rates using linear interpolation

Illustratively according to this aspect of the invention, the means for storing pressure differentials and corresponding flow rates comprises a lookup table.

Illustratively according to this aspect of the invention, the μC embodies a pressure differential-to-flow rate algorithm for converting the differences in pressure between the pressures sensed by respective second pressure sensors and the pressure sensed by the first pressure sensor into a flow rate in each respective channel.

Illustratively according to this aspect of the invention, the apparatus further includes displays corresponding to the plurality of channels. The displays are each adapted to display a selected parameter of a respective channel. Means are provided for selecting which parameter of the respective channel is to be displayed. The displays indicate the selected parameter.

Illustratively according to this aspect of the invention, the apparatus further includes means for adjusting a parameter of a respective channel.

Illustratively according to this aspect of the invention, the apparatus includes another input. The means for adjusting a parameter of a respective channel includes an orientation in which the other input controls the parameter of the respective channel.

Illustratively according to this aspect of the invention, the other input comprises an input selected from at least one analog port and a serial node adapter.

Illustratively according to this aspect of the invention, the apparatus includes a switch for selecting the other input.

Illustratively according to this aspect of the invention, the at least one analog port is adapted selectively to receive one of a voltage input and a current input.

Illustratively according to this aspect of the invention, the apparatus further includes a switch for configuring the at least one analog port to receive one of a voltage input and a current input.

Illustratively according to this aspect of the invention, the apparatus further includes at least one port for providing a selected flow rate in a respective channel.

Illustratively according to this aspect of the invention, the apparatus further includes at least one port for inhibiting adjustment of a parameter of a respective channel.

Illustratively according to this aspect of the invention, the apparatus includes means for placing the apparatus in a mode in which selecting a parameter of one of channels controls the selected parameter of the remaining channels.

Illustratively according to this aspect of the invention, the means for placing the apparatus in a mode in which selecting a parameter of one of channels controls the selected parameter of the remaining channels comprises a switch.

According to another aspect of the invention, a method for dispensing coating material through multiple dispensing devices includes sensing the pressure of a stream at a common point in a flow circuit, separately sensing pressures in a plurality of channels in the flow circuit, and controlling the flows of the stream in the respective dispensing devices based upon the combined sensed pressure and separately sensed pressures in the plurality of channels.

Illustratively according to this aspect of the invention, the method further includes providing a two conductor serial connection, a first conductor of which provides a clock signal and a second conductor of which provides a data signal. Controlling the flows of the stream in the respective channels includes providing a remote module and a sensor module, and transferring data from the sensor module to the remote module via the two conductor serial connection.

Illustratively according to this aspect of the invention, transferring data from the sensor module to the remote module includes the remote module setting said first conductor high and waiting until the sensor module drives the second conductor high in response, then the remote module driving the first conductor low, waiting a time, driving the first conductor high, and then sampling the signal on the second conductor to recover data from the sensor module.

Illustratively according to this aspect of the invention, the method includes conducting the sequence once for each bit of data that is transferred from the sensor module to the remote module.

Illustratively according to this aspect of the invention, the method further includes transferring data from the remote module to the sensor module via the two conductor serial connection to calibrate the sensor module.

Illustratively according to this aspect of the invention, transferring data from the remote module to the sensor module via the two conductor serial connection to calibrate the sensor module comprises transferring data from the remote module to the sensor module via the two conductor serial connection to calibrate the sensor module via said first conductor.

Illustratively according to this aspect of the invention, separately sensing pressures in the plurality of channels in the flow circuit further includes analog-to-digital (A/D) converting signals produced in a plurality of sensors for sensing flow through the plurality of channels.

Illustratively according to this aspect of the invention, the method further includes coupling the A/D converted signals to a microcontroller in the sensor module.

Illustratively according to this aspect of the invention, coupling the A/D converted signals to a microcontroller (μC) in the sensor module comprises time division multiplexing the A/D converted signals.

Illustratively according to this aspect of the invention, sensing the pressure of the stream at the common point in the flow circuit and separately sensing pressures in the plurality of channels in the flow circuit include converting the differences in pressure between the separately sensed pressures and the common pressure into the flows through the plurality of channels.

Illustratively according to this aspect of the invention, converting the differences in pressure between the separately sensed pressures and the common pressure into the flows through the plurality of channels includes interpolating between stored pressure differentials and corresponding flow rates.

Illustratively according to this aspect of the invention, interpolating between stored pressure differentials and corresponding flow rates includes linearly interpolating between stored pressure differentials and corresponding flow rates.

Illustratively according to this aspect of the invention, converting the differences in pressure between the separately sensed pressures and the common pressure into the flows through the plurality of channels includes using a lookup table.

Illustratively according to this aspect of the invention, converting the differences in pressure between the separately sensed pressures and the common pressure into the flows through the plurality of channels includes using a pressure differential-to-flow rate algorithm.

Illustratively according to this aspect of the invention, the method further includes providing a plurality of displays corresponding to the plurality of channels and displaying on the displays parameters of the respective channels. The displays are each adapted to display a selected parameter of a respective channel. Means are provided for selecting which parameter of the respective channel is to be displayed and for indicating the selected parameter.

Illustratively according to this aspect of the invention, the method further includes adjusting a parameter of a respective channel.

Illustratively according to this aspect of the invention, adjusting a parameter of a respective channel includes providing another input and providing means having an orientation in which control of the parameter of the respective channel is relinquished to the other input.

Illustratively according to this aspect of the invention, providing the other input comprises providing an input selected from at least one analog port and a serial node adapter.

Illustratively according to this aspect of the invention, providing the other input comprises providing multiple other inputs and selecting the other input from among the multiple other inputs based upon the position of a switch.

Illustratively according to this aspect of the invention, providing an input selected from at least one analog port includes receiving an input selected from at least one analog port which can be configured to receive one of a voltage input and a current input.

Illustratively according to this aspect of the invention, receiving an input selected from at least one analog port which can be configured to receive one of a voltage input and a current input includes receiving an input selected from at least one analog port which can be configured to receive one of a voltage input and a current input based upon the position of a switch.

Illustratively according to this aspect of the invention, the method further includes providing at least one port for establishing flow at either zero flow or a predetermined non-zero flow rate.

Illustratively according to this aspect of the invention, the method further includes providing at least one port for inhibiting adjustment of a parameter of a respective channel.

Illustratively according to this aspect of the invention, the method includes controlling a selected parameter of at least a second one of the channels based upon selection of a parameter of a first one of the channels.

Illustratively according to this aspect of the invention, controlling a selected parameter of at least a second one of the channels based upon selection of a parameter of a first one of the channels comprises controlling a selected parameter of at least a second one of the channels based upon selection of a parameter of a first one of the channels based upon the position of a switch.

### BRIEF DESCRIPTION OF THE DRAWINGS

The invention may best be understood by referring to the following detailed description and accompanying drawings which illustrate the invention. In the drawings:

FIG. 1 illustrates a partly block and partly schematic diagram of a system incorporating a control method and apparatus according to the invention;

FIG. 2 illustrates functions executed by (a) component(s) of the system illustrated in FIG. 1; and,

FIG. 3 illustrates functions executed by (a) component(s) of the system illustrated in FIG. 1.

### DETAILED DESCRIPTIONS OF ILLUSTRATIVE EMBODIMENTS

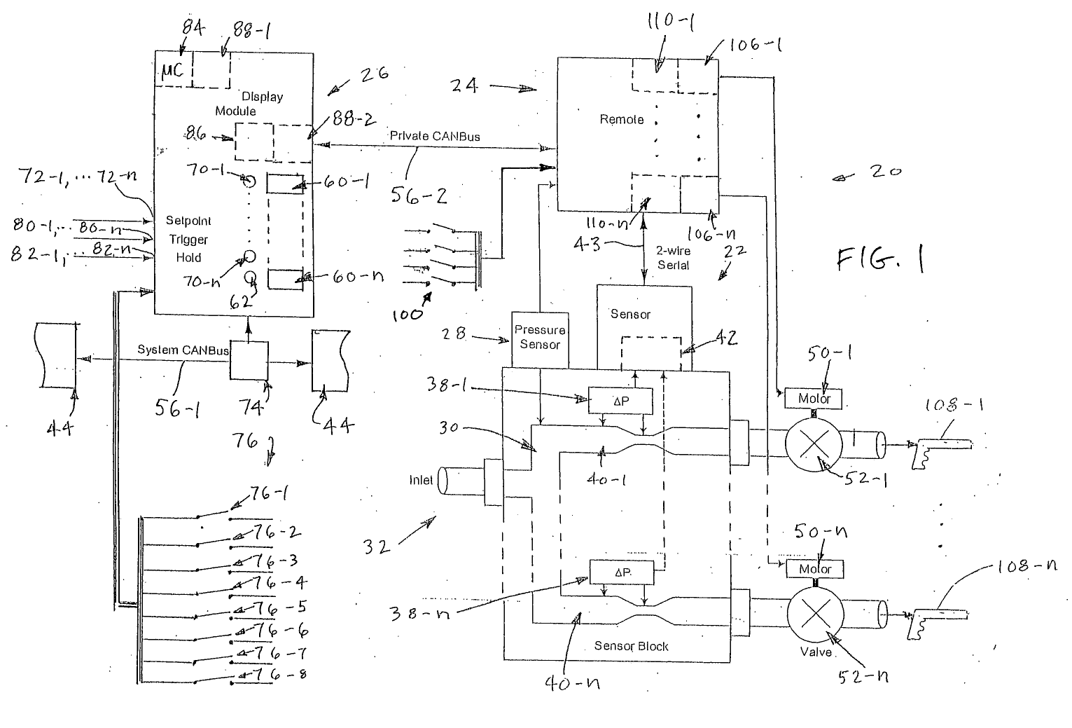

Turning now particularly to FIG. 1, a system 20 incorporating a control method and apparatus according to the invention includes a flow sensor module 22, a remote electronics module 24 and a display module 26.

Flow sensor module 22 includes a pressure sensor 28 which senses the pressure at some common point, such as a manifold 30 in a flow circuit 32 of a stream, such as, for example, a stream of air. Flow sensor module 22 also includes some number n of differential pressure transducers 38-1, . . . 38-n, each of which senses flow through a respective channel 40-1, . . . 40-n in flow circuit 32. Each differential pressure transducer 38-1, . . . 38-n produces a millivolt range electrical signal which it analog-to-digital (A/D) converts. These A/D converted pressure differential signals are coupled, for example, time division multiplexed, to a microcontroller (μC)-based circuit 42 in flow sensor module 22. Circuit 42 converts the differences in pressure between the pressures sensed by respective transducer 38-1, . . . 38-n and the common pressure from sensor 28 into a flow rate in each respective channel 40-1, . . . . 40-n, for example, by means of a lookup table with interpolation, for example, linear interpolation, for pressure differentials between points in the lookup table, or by a pressure differential-to-flow rate algorithm, or by some other appropriate means. An illustrative lookup table might include A/D representations of ten flow rates, with linear interpolation for flow rates between lookup table entries. The flow information is coupled, for example, over a two-conductor link 43 using a suitable format, to remote electronics module 24.

Remote electronics module 24 then converts the A/D representations of the serially supplied flow rates into commands to stepper motors 50-1, . . . 50-n associated with valves 52-1, . . . 52-n which control the flows through the respective channels 40-1, . . . 40-n. Illustratively, remote electronics module 24 includes a μC that executes a control loop algorithm that determines the correct position for each stepper motor 50-1, . . . 50-n for a given commanded flow rate in its respective channel 40-1, . . . 40-n. The commanded flow rates for the various channels 40-1, . . . 40-n are provided, for example, from the display module 26 over a data link such as, for example, a Controller Area Network bus (CANbus) 56. The remote electronics module 24 responds over the data link 56 with status information including actual flow rates in the various channels 40-1, . . . 40-n, pressure at the common point 30, and so on. The n channels 40-1, . . . 40-n are capable of operating independently. Each channel 40-1, . . . 40-n has its own flow set point and stepper motor 50-1, . . . 50-n control loop.

Display module 26 serves not only to display system 20 status, but also as a communication link between system 20 and other equipment 44, such as that described in, for example, U.S. Pat. Nos. 6,562,137; 6,423,142; 6,144,570; 5,978,244; or, 5,318,065, illustratively also by means of a CANbus 56. The disclosures of these references are hereby incorporated herein by reference. This listing is not intended to be a representation that a complete search of all relevant art has been made, or that no more pertinent art than that listed exists, or that the listed art is material to patentability. Nor should any such representation be inferred.

Display module 26 provides n LED display arrays, one for each channel 40-1, . . . 40-n, front panel potentiometers for operator set point, trigger and/or hold commands, and (a) back panel input port(s) for, for example, wired set point, trigger, and/or hold inputs. The display module 26 can be configured by means of, for example, an array of switches such as a Dual Inline Package (DIP) switch, from a remote source such as a serial node adapter, or from a local source, such as a front panel potentiometer or back panel voltage or current loop input.

Display module 26 additionally can be configured either to operate the n channels 40-1, . . . 40-n independently, as previously discussed, or to designate a master channel and (a) slave channel(s) and designate (a) ratio(s) of the throughputs of the respective master and slave channels. The display module 26 determines the correct set points for each channel 40-1, . . . 40-n based upon the configuration inputs and set point, trigger and/or hold command inputs and provides the necessary information to the remote module 24. The illustrated remote module 24 is not signaled regarding the status, that is, whether independent or master/slave, of the various channels 40-1, . . . 40-n. It simply receives the necessary commands and executes them.

Display module 26 communicates with the node adapter, where a node adapter is present, and with the remote module 24. Display module 26 provides the set point, trigger and hold commands for the remote module 24. In master/slave mode, display module 26 computes individual channels 40-1, . . . 40-n's set points and maintains their desired flow rates and ratios. Display module 26 also displays flow and pressure information received from the remote module 24. Display module 26 does not directly control airflow. All user inputs are coupled to display module 26. Display module 26 operates two CANbus 56 channels 56-1 and 56-2. One of these channels 56-1 is associated with equipment 44. The other of these channels 56-2 is associated with the remote module 24.

Remote module 24 communicates only with display module 26 and sensor module 22. Remote module 24 has direct control of the stepper motors 50-1, . . . 50-n associated with valves 52-1, . . . 52-n which control the flows through the respective channels 40-1, . . . 40-n. Remote module 24 controls stepper motor 50-1, . . . 50-n positions required for desired flow rates in channels 40-1, . . . 40-n. Remote module 24 also monitors the inlet pressure at 30 of the sensor module 22.

Sensor module 22 computes actual flow in each channel 40-1, . . . 40-n from the pressure differentials measured by the sensor module 22, and provides the computed flow information to remote module 24. Sensor module 22 does not control flow. The differential pressure transducers 38-1, . . . 38-n are in the respective flow paths 40-1, . . . 40-n.

Turning now to the details of the various modules, display module 26 includes a front panel 48 having n display windows 60-1, . . . 60-n, one for each channel 40-1, . . . 40-n. These display windows 60-1, . . . 60-n can be independently set to display set points, actual flows or status, that is, error codes. A front panel SELECT switch 62, such as, for example, a push button switch, cycles the display in a particular window 60-1, . . . 60-n, and LEDs associated with each window 60-1, . . . 60-n is illuminated to indicate which of SET for set point, ACT for actual flow rate, or STS for status, is being displayed in its associated window 60-1, . . . 60-n. Error codes are displayed as alphanumeric codes, for example, “E” followed by a three digit code. In the absence of errors, requests for system 20 status result in the display of inlet pressure, which is displayed for example as “P” followed by a two digit pressure reading in pounds per square inch.

Front panel potentiometers 70-1, . . . 70-n provide operator control of flow setpoints and master/slave ratios when these are enabled. When any of potentiometers 70-1, . . . 70-n are in one position, for example, full counterclockwise, their associated channels 40-1, . . . 40-n, respectively, are under remote control. In the remote control mode, flow setpoints and ratio commands are provided from analog ports 72-1, . . . 72-n, or from serial node adapter 74, depending upon the setting of DIP switch 76. Analog ports 72-1, . . . 72-n can be configured to provide voltage signals, for example, 0-10 VDC, or current signals, for example, 4-20 mA, depending upon the setting of DIP switch 76.

Additional ports 80-1, . . . 80-n, 82-1, . . . . 82-n are provided for trigger (80) and hold (82) control for each channel 40-1, . . . 40-n. Ports 80-1, . . . 80-n can be configured for active high level control (source provides 24 VDC when active) or active low control (source provides 0 VDC when active). Trigger control permits flow to be controlled with a discrete (on/off) control once a set point has been established. When a trigger is off, the respective stepper motor 50-1, . . . 50-n will immediately go to a zero position, halting airflow through a respective channel 40-1, . . . 40-n. When the trigger is on, a respective stepper motor 50-1, . . . 50-n will open its respective valve 52-1, . . . 52-n sufficiently to support the desired airflow in its respective channel 40-1, . . . 40-n.

The hold commands at ports 82-1, . . . 82-n “freeze” their respective flow control loops when flow is being controlled by external on/off valves. Such a hold command freezes a respective stepper motor 50-1, . . . 50-n and its respective valve 52-1, . . . 52-n at their current positions just prior to a closing of the external on/off valve. The stepper motor 50-1, . . . 50-n and valve 52-1, . . . 52-n remain in these positions until the hold command is removed.

Illustrative DIP switch 76 settings and their associated actions include: switch 76-1 “on” places the system 20 in master/slave mode in which one of channels 40-1, . . . 40-n, illustratively channel 40-1, serves as the master channel, and the remaining channel(s) 40-2, . . . 40-n are slaved to it; switch 76-1 “off” places channel 40-1, . . . 40-n in independent mode; switch 76-2 “on” smooths the display; switch 76-3 “on” inhibits low end control; switch 76-4 “on” enables voltage ramp-up; switch 76-5 “on” enables high tolerance; switch 76-5 “off” enables low tolerance; switch 76-6 is not used in the illustrated embodiment; switch 76-7 “on” configures ports 72-1, . . . 72-n to provide current signals, for example, 4-20 mA; switch 76-7 “off” configures ports 72-1, . . . 72-n to receive voltage input signals, for example, 0-10 VDC; switch 76-8 “on” configures the mode in which flow setpoints and ratio commands are provided from analog ports 72-1, . . . 72-n; and, switch 76-8 “off” configures the mode in which flow setpoints and ratio commands are provided from serial node adapter 74.

Display module 26 includes a μC 84 which provides an internal A/D converter and CANbus 56-1 interface. μC 84 illustratively is a Philips 87C591 μC. The internal One-Time Programmable (hereinafter sometimes OTP) memory of μC 84 is not used. Program memory is provided by a separate memory μC such as, for example, a 27C512 EPROM. Second CANbus 56-2 interface is provided by a CAN controller 86, such as, for example, a Philips SJA 1000 CAN controller. Physical layer interfaces 88-1 and 88-2 are provided between μC 84 and CANbus 56-1 and between CAN controller 86 and CANbus 56-2. Interfaces 88 illustratively are Siliconix Si9200EY CANbus driver ICs. Displays 60-1, . . . 60-n illustratively are Agilent HCMS2956 four-character 5 by 7 dot matrix display modules which are driven through a serial interface of μC 84. Ports 72-1, . . . . 72-n are buffered, illustratively through LM358 operational amplifiers with voltage dividers for the 0-10 VDC inputs. When ports 72-1, . . . 72-n are configured for 4-20 mA operation, they are shunted, illustratively by MOSFETs which place 500 Ω resistors across their respective inputs. An onboard switching regulator provides regulated 5 VDC local power.

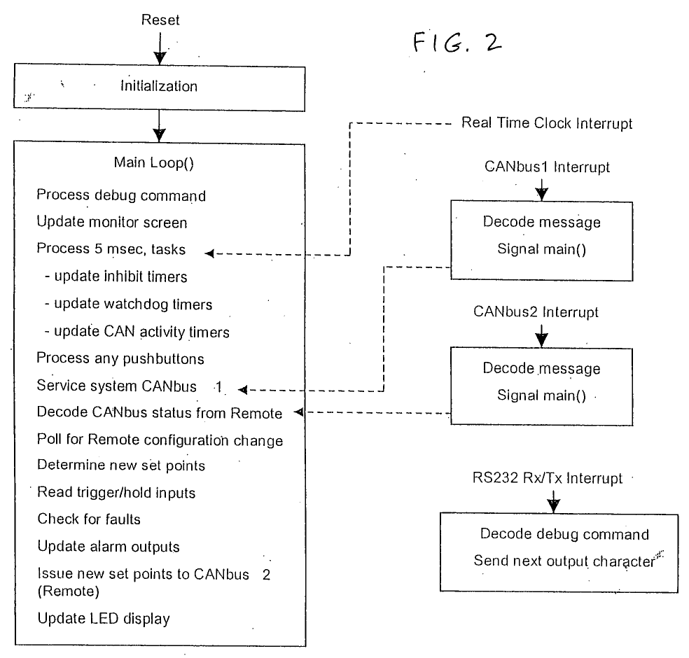

The software for display module 26 is illustrated in FIG. 2. The display module 26 software includes a main polling loop and interrupt handlers to handle real-time events. Interrupt handlers are provided for a 5 msec. real-time clock, CANbus interfaces 88-1, 88-2, and an RS-232 debug port. The interrupt handlers set flags when action by the main loop is required. Integrated debug monitor and command interpreters are provided to support software development. RS-232 character input/output is fully interrupt driven. Output characters are stored in a 500-byte circular buffer until they can be sent. All low-level standard buffered input/output (hereinafter sometimes stdio) display formatting routines are provided, so that no run-time library is required.

CANbus commands from the serial node adapter 74 and status messages from the remote module 24 are decoded in the interrupt service routine. Then a flag is set to request service from the main loop. The display module 26 operates as a slave to the serial node adapter 74. Status messages are sent upon receipt of a command to display status.

Every 20 msec., the display module 26 updates the remote module 24 with a new set of set points, trigger/hold bits and other control flags. New set points may come from a serial node adapter 74 command message, analog ports 72-1, . . . 72-n, potentiometers 70-1, . . . 70-n, and so on. To reduce the occurrence of spurious faults, fault conditions are inhibited for, for example, 10 seconds after a trigger or when points change by more than a predetermined amount, such as, for example, 10%. Trigger and hold bits may be supplied with the serial node adapter 74 command or by discrete inputs from ports 80-1, . . . 80-n, 82-1, . . . . 82-n.

Control flags include a “ramp enable” bit, a “conduit fault enable” bit and two fault inhibit bits. The “ramp enable” bit is provided by switch 76-4. The “conduit fault enable” bit is enabled by conduit fault enable logic in remote module 24. The fault inhibit bits are employed under control of serial node adapter 74.

In response to the set point command, the remote module 24 responds with a status message. This status message is processed by the CANbus 56-2 interrupt handler and comprises actual flow for each channel 40-1, . . . 40-n, inlet pressure and n bytes of status flags, one for each channel 40-1, . . . 40-n. The decoded data is used by the main loop to update the LED display and to determine if any faults have occurred. Status bits are passed along to the serial node adapter 74 to reflect the following error conditions:

inlet pressure less than 75 p. s. i. g. (about 3.5×10⁴ Pa g.) or greater than 95 p. s. i. g. (about 4.46×10⁴ Pa g.)

actual flow greater than the set point plus a tolerance value;

actual flow less than the set point minus a tolerance value.

Illustrative tolerance values are ±10% of set point (low tolerance) and ±24% of set point (high tolerance), and may be set by the on-board DIP switch 76-5.

Every 100 setpoint updates, the display module 26 sends a command to the remote module 24 to provide its current configuration. This signals the display module 26 of the maximum flow of the sensor 38-1, . . . 38-n on each channel 40-1, . . . 40-n from which the analog inputs can then be scaled correctly.

To permit synchronization of the stepper motors 50-1, . . . 50-n, the display module 26 issues a “re-zero” command upon the removal of every sixth trigger signal. This causes the remote module 24 to issue additional steps in the reverse direction to drive the motors 50-1, . . . 50-n toward their respective true zero positions.

The front panel LED display 60-1, . . . 60-n is refreshed every 250 msec. If display smoothing is enabled at DIP switch 76-2, actual flow values within +2% of setpoint are displayed as the actual setpoint. Otherwise, actual flows are normally displayed. If low end inhibit is enabled on DIP switch 76-3, actual flow values less than 5% of full scale are displayed as zero.

Error codes are illustratively displayed as the letter E followed by a digit according to the following list: “1” indicates inlet pressure too low; “2” indicates inlet pressure too high; “3” indicates flow too low; “4” indicates flow too high; and, “5” indicates loss of communication with remote module 24. Illustratively, a maximum of three error codes can be displayed at any time. This is ordinarily sufficient, since some of these errors are mutually exclusive.

The remote module 24 communicates with the display module 26 via CANbus 56-2. This permits the remote module 24 to be located some distance from the display module 26 without compromising the integrity of CANbus 56-1.

The remote module 24 also communicates with sensor module 22, monitors the inlet air pressure at 30 and controls the stepper motors 50-1, . . . 50-n that operate the flow control valves 52-1, . . . 52-n.

A four position DIP switch 100 configures the system for the sensor module 22 capacity, for example, 100, 300, 750 or 1200 standard liters per minute (hereinafter sometimes slpm). Switch 100 indicates to the software the maximum allowable flow rate, the number of stepper motor 50-1, . . . 50-n steps between fully closed and fully opened and other control parameters required by the software. Few, if any, additional operator adjustments or setup adjustments are contemplated in the illustrated embodiment.

(n+1) 24 VDC-sourcing output ports are provided, one each for a master valve and a trigger valve for each channel 40-1, . . . 40-n. The master valve is enabled whenever power is applied to the remote module 24. The trigger output signals track the trigger data bits provided by the display module 26.

The illustrated remote module 24 uses the same Philips 87C591 μC and 27C512 external EPROM configuration as the display module 26. Since only a single CANbus interface is required, the integrated CAN controller provided on the Philips 87C591 μC is used in the remote module 24.

The stepper motor controllers 106-1, . . . 106-n associated with respective stepper motors 50-1, . . . 50-n illustratively are Infineon TCA3727G controllers. One controller 106-1, . . . 106-n is provided for each channel 40-1, . . . 40-n. These controllers provide direct control of the 24 VDC stepper motors 50-1, . . . 50-n without any interface requirements.

The trigger outputs to the dispensing devices 108-1, . . . 108-n on the outputs of channels 40-1, . . . 40-n, respectively, are provided by solid state relays 110-1, . . . 110-n, respectively.

A switching regulator of the same general type that provides +5 VDC power from +24 VDC to display module 26 provides power to remote module 24.

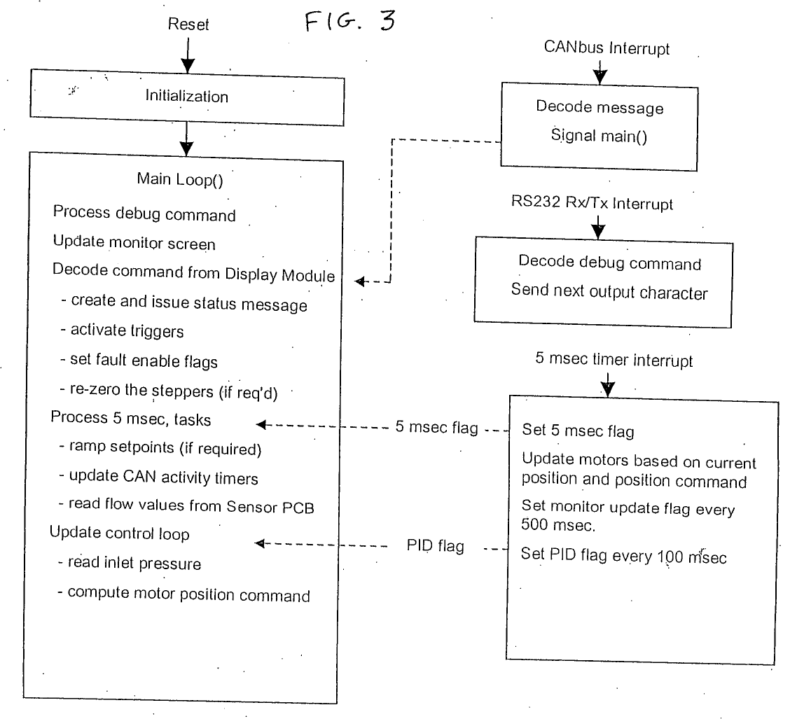

The remote module 24 software is illustrated in FIG. 3. The remote module software 24 is of similar structure and design to the display module 26 software. A single main polling loop provides the majority of the functionality, with interrupt handlers to process real time events.

The CANbus interrupt handler processes the received packets from the display module 26, extracting the command code and passing message data on to the main loop. The message data includes two setpoints, and trigger, hold, ramp enable and fault inhibit control bits.

The RS-232 support is identical to that employed in the display module 26. The software is provided with an integrated debug monitor.

Communication with the sensor module 22 takes place over two conductor serial connection 43. One of conductors 43 carries a clock signal. The other carries a data signal. Data is transferred from the sensor module 22 to the remote module 24. At the end of each data transfer, two bits of data are sent back to the sensor module 22 over conductors 43 for calibration purposes. To initiate a transfer, the remote module 24 sets the clock conductor high and waits for the sensor module 22 to drive the data conductor high in response. This process permits the sensor module 22's μC to complete whatever task it is currently executing before devoting its attention to serial data transfer. Interrupts are temporarily disabled on the remote module 24's μC to make the sequence that follows deterministic. The remote module 24 drives the clock low, waits a preset time, drives the clock high, and then samples the signal on the data line to extract a bit of data from the sensor module 22. This sequence is repeated sixteen times to transfer a sixteen-bit word of channel m actual flow rate data from the sensor module 22. This sequence is repeated for each channel m, 1<m<n. At the end of this transfer, a number of additional clock pulses are transferred from the remote module 24 to provide the two bits of calibration data. No data is transferred from the sensor module 22 during this calibration interval.

The sensor module 22 includes a Microchip 16C77 μC and an external millivolt-level A/D converter with power supply and support logic, such as the ITW GEMA part number 379786. The software in the ITW GEMA part's Microchip 16C77 μC is modified to support the sensor module 22's two-wire serial communication link 43 with the remote module 24 and to implement a lookup table for A/D code conversion into flow data. The lookup table is stored in an EEPROM in remote module 24.

Flow values are computed from A/D converter codes by means of the lookup table. The table has, for example, ten entries, each including an A/D code and a corresponding flow rate. To compute a flow rate from received data, the software scans the lookup table, finds a pair of adjacent entries, one greater than the received A/D code and one less than the received A/D code, and uses linear interpolation between the corresponding flow rates to calculate the received flow rate.

The sensor module 22 software also supports a calibration mode in which the operator is instructed to adjust the valve manually to produce a given flow rate which is measured by an accurate external flowmeter. The μC then reads the A/D code and creates an entry in the lookup table.

What is claimed is:

1. Apparatus for dispensing coating material through multiple dispensing devices, the apparatus including a first pressure sensor which senses the pressure of a stream at a common point in a flow circuit, a number of second pressure sensors, each of which senses flow through a respective channel in the flow circuit, and a controller for controlling the flows of the stream in the respective channels based upon the combined inputs of the first pressure sensor and second pressure sensors.

2. The apparatus of claim 1 further including a two conductor serial connection a first conductor of which provides a clock signal and a second conductor of which provides a data signal, the controller including a remote module and a sensor module, data being transferred from the sensor module to the remote module via the two conductor serial connection.

3. The apparatus of claim 3 wherein the sensor module and remote module comprise a remote module for setting the first conductor high and waiting for the sensor module to drive the second conductor high in response, then the remote module driving the first conductor low, waiting a time, driving the first conductor high, and then sampling the signal on the second conductor to recover data from the sensor module.

4. The apparatus of claim 3 wherein the sensor module and remote module comprise a the sensor module and remote module for conducting the sequence once for each bit of data that is transferred from the sensor module to the remote module.

5. The apparatus of claim 2 wherein the remote module and sensor module comprise a remote module and sensor module for sending data from the remote module to the sensor module via the two conductor serial connection to calibrate the sensor module.

6. The apparatus of claim 5 wherein the remote module and sensor module for sending data from the remote module to the sensor module via the two conductor serial connection to calibrate the sensor module comprise a remote module and sensor module for sending data from the remote module to the sensor module via said first conductor.

7. The apparatus of claim 1 further comprising an analog-to-digital (A/D) converter for each second pressure sensor.

8. The apparatus of claim 7 further including a microcontroller (μC) in the flow sensor module, the A/D converted pressure signals being coupled to the μC.

9. The apparatus of claim 8 wherein the A/D converted pressure signals to the μC are time division multiplexed.

10. The apparatus of claim 9 wherein the μC converts the differences in pressure between the pressures sensed by respective second pressure sensors and the pressure sensed by the first pressure sensor into a flow rate in each respective channel.

11. The apparatus of claim 10 further including means for storing pressure differentials and corresponding flow rates.

12. The apparatus of claim 11 wherein the μC converts the differences in pressure between the pressures sensed by respective second pressure sensors and the pressure sensed by the first pressure sensor into a flow rate in each respective channel among the stored pressure differentials and corresponding flow rates using interpolation.

13. The apparatus of claim 12 wherein the μC converts the differences in pressure between the pressures sensed by respective second pressure sensors and the pressure sensed by the first pressure sensor into a flow rate in each respective channel among the stored pressure differentials and corresponding flow rates using linear interpolation

14. The apparatus of claim 11 wherein the means for storing pressure differentials and corresponding flow rates comprises a lookup table.

15. The apparatus of claim 10 wherein the μC embodies a pressure differential-to-flow rate algorithm for converting the differences in pressure between the pressures sensed by respective second pressure sensors and the pressure sensed by the first pressure sensor into a flow rate in each respective channel.

16. The apparatus of claim 1 further including displays corresponding to the plurality of channels, the displays each adapted to display a selected parameter of a respective channel, means for selecting which parameter of the respective channel is to be displayed, the displays indicating the selected parameter.

17. The apparatus of claim 16 further including means for adjusting a parameter of a respective channel.

18. The apparatus of claim 17 including another input, wherein the means for adjusting a parameter of a respective channel includes an orientation in which the other input controls the parameter of the respective channel.

19. The apparatus of claim 18 wherein the other input comprises an input selected from at least one analog port and a serial node adapter.

20. The apparatus of claim 19 including a switch for selecting the other input.

21. The apparatus of claim 19 wherein the at least one analog port is adapted selectively to receive one of a voltage input and a current input.

22. The apparatus of claim 21 further including a switch for configuring the at least one analog port to receive one of a voltage input and a current input.

23. The apparatus of claim 16 further including at least one port for providing a selected flow rate in a respective channel.

24. The apparatus of claim 16 further including at least one port for inhibiting adjustment of a parameter of a respective channel.

25. The apparatus of claim 16 including means for placing the apparatus in a mode in which selecting a parameter of one of channels controls the selected parameter of the remaining channels.

26. The apparatus of claim 25 wherein the means for placing the apparatus in a mode in which selecting a parameter of one of channels controls the selected parameter of the remaining channels comprises a switch.
